(19) United States
(12) Patent Application Publication
(10) Pub. No.: US 2015/0127332 A1
(43) Pub. Date: May 7, 2015

(54) SYSTEM AND METHOD OF IMPROVING SIGNAL-TO-NOISE RATIO

(71) Applicants: INVENTEC APPLIANCES (PUDONG) CORPORATION, Shanghai (CN); INVENTEC APPLIANCES CORP., New Taipei City (TW); INVENTEC (JIANGNING) CORPORATION, Nanjing (CN)

(72) Inventors: Ji-Bin YI, Nanjing (CN); Wen-Hui QIU, Nanjing (CN)

(21) Appl. No.: 14/527,507

(22) Filed: Oct. 29, 2014

(30) Foreign Application Priority Data
Nov. 5, 2013 (CN) 201310542561.X

(51) Int. Cl. G10L 21/0208; H04M 9/08

(52) U.S. Cl. CPC G10L 21/0208; H04M 9/085
USPC 704/226

(57) ABSTRACT

A method of improving signal-to-noise ratio is provided. The method includes acquiring a digital audio signal output from an endec by a host processing unit interface; receiving the digital audio signal output from the host processing unit interface by an audio engine interface; transmitting the digital audio signal from the audio engine interface to an audio engine processor; reducing noise of the digital audio signal by the audio engine processor and then converting the digital audio signal into an analog audio signal to be played.

### FIELD OF THE INVENTION

The present invention relates to communication technology and, in particular, to a method and system of improving signal-to-noise ratio.

### BACKGROUND OF THE INVENTION

Cell phones have become and continue to be very popular voice communication devices and the request for voice communication in good quality is an important issue today. In wireless communication between electronic devices, an audio signal is easily to be affected by noises from the external communication network and the internal electronic elements inside the devices. These noises are unfavorable to the quality of voice communication.

FIG. 1 shows a well-known voice and audio signal transmitting system. A voice data goes through an analog-to-digital converter (ADC), an encoder and a modem 12 inside a host processing unit 1 to respectively undergo an analog-to-digital conversion, an encoding, and a modulation. And then a demodulated signal is output from the modem 12, goes through a decoder and a digital-to-analog converter (DAC) to respectively undergo a decoding and a digital-to-analog conversion, and is finally converted into an analog audio signal. The analog audio signal is transmitted to an audio engine 2 and then played by an audio player 26 in the system such as a speaker, a receptor or a headphone.

Music data and video data are transmitted between a host processing unit interface 15 and an audio engine interface 25. The above-mentioned interfaces are parallel bus interfaces. After being transmitted to the audio engine interface 25, the music data and video data are played by the audio player 26 in the system such as the speaker, the receptor or the headphone.

Most specialists make efforts in increasing radio-frequency or optimizing circuitry design so that the noise can be reduced during voice communication, and then the voice communication quality is improved. However, these ways are not able to completely eliminate the noise effects.

### SUMMARY OF THE INVENTION

The invention provides a system and a method of improving signal-to-noise ratio, which completely eliminates the noise effects during voice communication.

According to the above object, the invention provides a method of improving signal-to-noise ratio of a portable communication device, comprising steps of: acquiring a digital audio signal output from an endec of a host processing unit by a processing unit interface; receiving the digital audio signal transmitted from the host processing unit interface by an audio engine interface; transmitting the digital audio signal from the audio engine interface to an audio engine processor; reducing noise of the digital audio signal by the audio engine processor and then converting the digital audio signal to an analog audio signal to be played.

Moreover, the method of improving signal-to-noise ratio of a portable communication device further comprises steps of: encoding/decoding a call data received by the portable communication device by the endec to generate the digital audio signal before the step of acquiring the digital audio signal.

Moreover, the method of improving signal-to-noise ratio of a portable communication device further comprises steps of: playing the analog audio signal by an audio player.

Moreover, the method of improving signal-to-noise ratio of a portable communication device comprises steps of: transmitting a music data from the processing unit interface to the audio engine interface; transmitting the music data from the audio engine interface to the audio engine processor; and playing the music data processed by the audio player.

Preferably, the audio engine processor is performed by applying an audio noise reduction program.

Preferably, the audio player includes a handsfree device, a telephone receiver, or a headset of the portable communication device.

Meanwhile, the invention provides a signal-to-noise ratio improving system, comprising: a host processing unit including an endec and an processing unit interface, the processing unit interface for receiving a digital audio signal output from the endec; an audio engine including an audio engine processor and an audio engine interface, the audio engine interface for receiving the digital audio signal transmitted from the processing unit interface; wherein the audio engine processor is used to receive the digital audio signal transmitted from the audio engine interface, reduce noise of the digital audio signal, and convert the digital audio signal to an analog audio signal to be played.

Moreover, the endec encodes/decodes a call data received by the portable communication device to generate the digital audio signal.

Moreover, the processing unit interface further transmits a music data to the audio engine interface, and to transmit the music data to the audio engine processor, and the audio engine processor processes the music data.

Preferably, the audio player includes a handsfree device, a telephone receiver, or a headset of the portable communication device.

Meanwhile, the invention provides portable communication device capable of improving signal-to-noise ratio, comprising a processing unit including an endec and an processing unit interface, the processing unit interface for receiving a digital audio signal output from the endec; an audio engine including an audio engine processor and an audio engine interface, the audio engine interface for receiving the digital audio signal transmitted from the processing unit interface; wherein the audio engine processor is used to receive the digital audio signal transmitted from the audio engine interface, reduce noise of the digital audio signal, and convert the digital audio signal to an analog audio signal to be played.

Moreover, the portable communication device further includes an audio player to play the analog audio signal.

Moreover, the processing unit interface is used to transmit a music data to the audio engine interface; the audio engine interface is used to transmit the music data to the audio engine processor and the audio player is used to play the music data.

Preferably, the audio player includes a handsfree device, a telephone receiver, or a headset of the portable communication device.

The invention eliminates the noise effects in voice communication and improves the quality of voice communication without changing the hardware of portable communication devices.

### BRIEF DESCRIPTION OF THE DRAWINGS

The invention will become more fully understood from the detailed description given herein below illustration only, and thus is not limitative of the present invention, and wherein:

FIG. 1 is a diagram schematically illustrating a conventional voice and audio signal transmitting system;

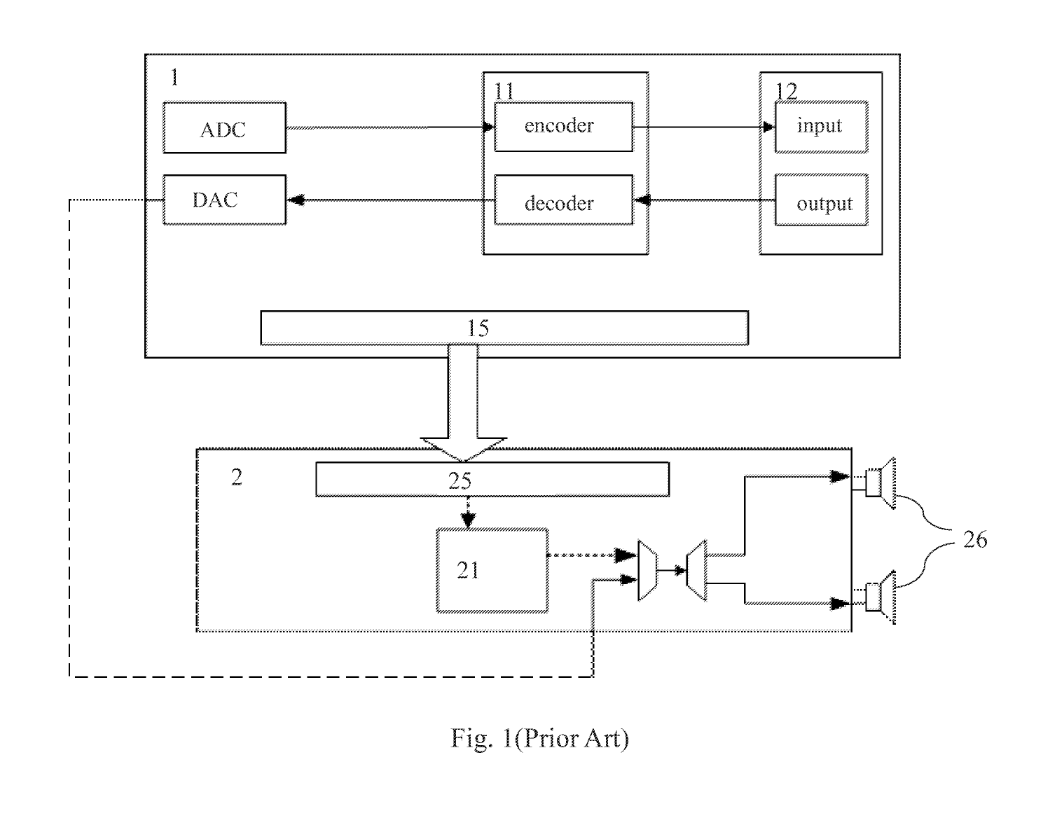

FIG. 2 is a diagram schematically showing a signal-to-noise ratio improving system according to a first embodiment of the invention;

FIG. 3 is a flow chart showing a music playing method of the signal-to-noise ratio improving method according to the first embodiment of the invention; and

FIG. 4 is a flow chart showing a signal-to-noise ratio improving method according to a second embodiment of the invention.

### DETAILED DESCRIPTION OF THE PREFERRED EMBODIMENT

The present invention will be apparent from the following detailed description, which reference to the accompanying drawings, wherein the same references relate to the same elements. The following paragraphs describe embodiments of the disclosed method and system of improving signal-to-noise ratio of the invention.

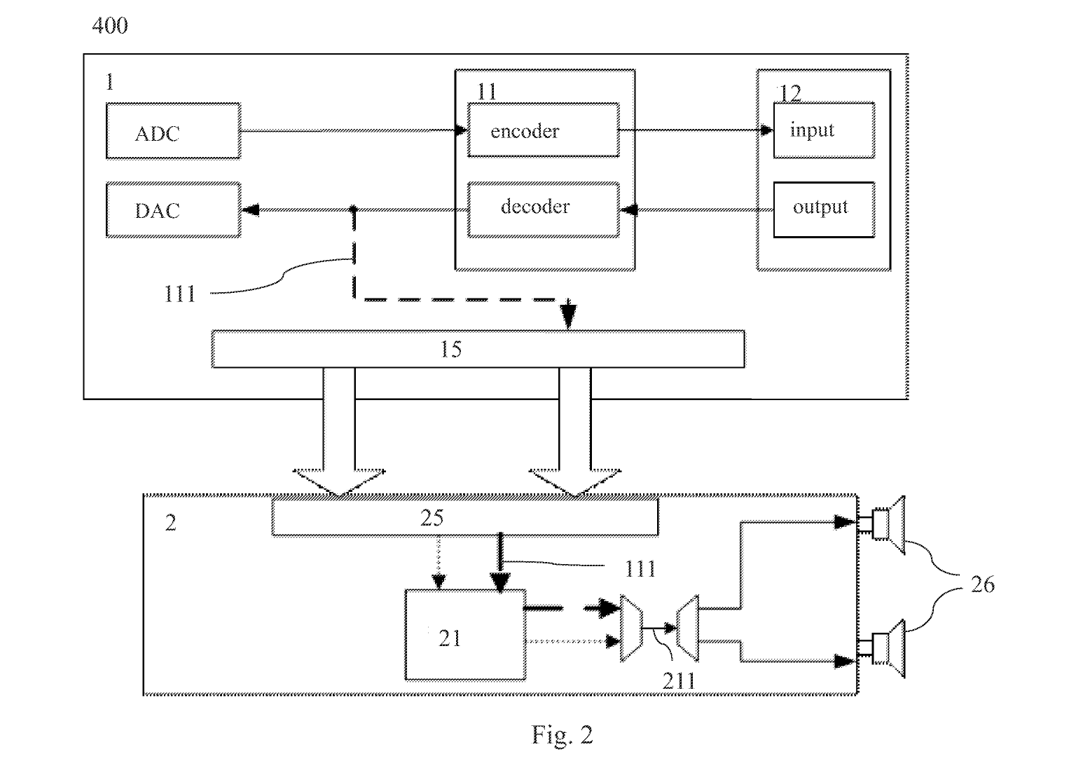

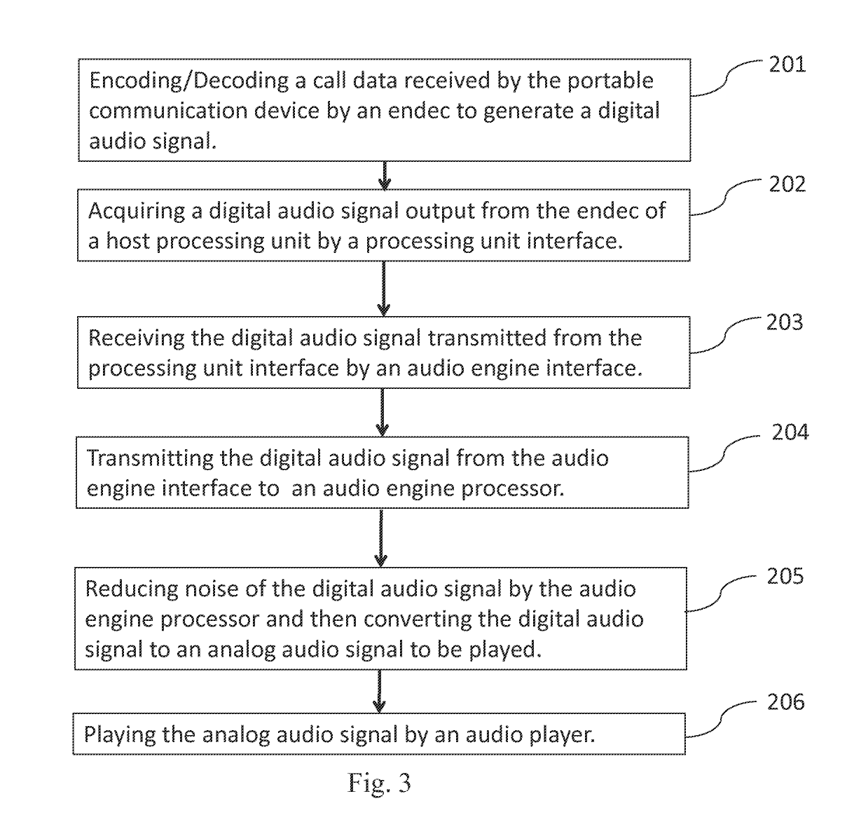

As shown in FIG. 2 and FIG. 3, the invention provides a method of improving signal-to-noise ratio (SNR) of a portable communication device including a host processing unit 1 and an audio engine 2 connected to the host processing unit 1, such as a cell phone, a phablet or a tablet computer. The invention improves the voice communication quality by reducing the effects of noise via a processor without changing the hardware of the portable communication device. The method of improving SNR comprises the following steps:

Step202: Acquiring a digital audio signal 111 output from an endec 11 of the host processing unit 1 by a processing unit interface 15.

In another embodiment, a step 201 as shown in FIG. 2 is performed before the step 202, the step 201 is that the portable communication device receives a call data and then encoding/decoding the call data to generate the digital audio signal 111.

Step203: Receiving the digital audio signal 111 transmitted from the host processing unit 1 by a processing unit interface 15, especially by the audio engine interface 25 of the audio engine 2; herein, the host processing unit interface 15 and the audio engine interface 25 are both parallel bus interface and in the following the host processing unit interface 15 would be called as the host processing unit bus interface and the audio engine interface 25 would be called as the audio engine bus interface.

Specifically, the bus interfaces are set on a motherboard to act as a mediator to receive and transmit all kinds of data. Different kinds of interface adaptors are installed onto the bus interfaces. Data then been transferred between the interface adaptors and the motherboard with these bus interfaces. A bus interface can be connected with a plurality of units. Different message-transmitting units deliver messages to the bus interface time-divisionally and then the bus interface delivers different messages to other message-receiving units simultaneously.

Step204: Transmitting the digital audio signal 111 from the audio engine interface 25 to an audio engine processor (DSP) 21.

Step205: Reducing noise of the digital audio signal 111 by the audio engine processor 21 and then converting the digital audio signal 111 to an analog audio signal to be played.

Preferably, the audio engine processor 21 reduces noise by an audio noise reduction program. Instead of playing the digital audio signal 111 by an audio player directly, the present invention reduces noise of the digital audio signal 111 by the audio engine processor 21, which eliminates the noise effects and improves the quality of voice communication.

Step206: Playing the analog audio signal 211 by an audio player 26.

Preferably, the audio player 26 includes a handsfree device, a telephone receiver, or a headset of the portable communication device.

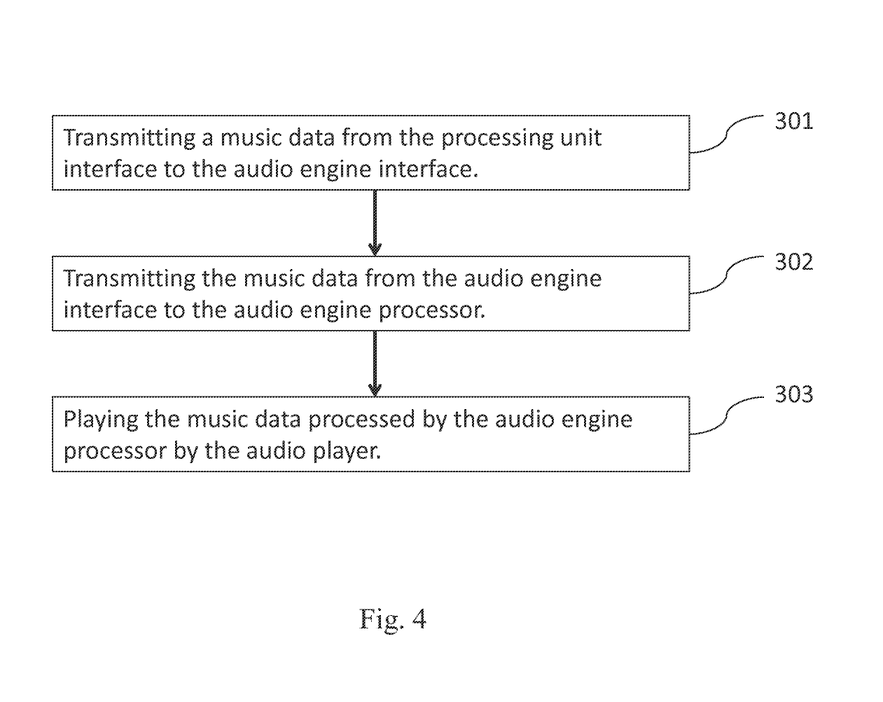

In another embodiment, as shown in FIG. 4, the method of improving signal-to-voice reduction of the portable communication device of the invention further comprises steps to play music data. These steps are as follows.

Step301: Transmitting a music data from the host processing unit interface 15 to the audio engine interface 25.

Step302: Transmitting the music data from the audio engine interface 25 to the audio engine processor 21.

Step303: Playing the music data by the audio player 26.

Meanwhile, as shown in FIG. 2, the invention provides a signal-to-noise ratio improving system 400. The system 400 includes: a host processing unit including an endec 11 and an processing unit interface 15, the processing unit interface 15 for receiving a digital audio signal 111 output from the endec 11; an audio engine 2 including an audio engine processor 21 and an audio engine interface 25, the audio engine interface 25 for receiving the digital audio signal 111 transmitted from the processing unit interface 15; wherein the audio engine processor 21 is used to receive the digital audio signal 111 transmitted from the audio engine interface 25, reduce noise of the digital audio signal 111, and convert the digital audio signal 111 to an analog audio signal 211 to be played.

In an embodiment, a portable communication device includes the signal-to-noise ratio improving system 400, wherein the host processing unit 1 and the audio engine 2 is respectively a center processing unit (CPU) and an audio unit of the portable communication device.

In another embodiment, the signal-to-noise ratio improving system 400 of the second embodiment of the invention also plays a music data. Furthermore, the host processing unit interface 15 transmits the music data to the audio engine interface 25 and then the audio engine interface 25 transmits the music data to the audio engine processor 21. The audio engine processor 21 then plays the music data by the audio player 26.

Although the invention has been described with reference to the preferred embodiments, this description is not meant to be construed in a limiting sense. It is apparent to those skilled in the art that a variety of modifications and changes may be made without departing from the scope of the present invention which is intended to be defined by the appended claims.

What is claimed is:

1. A method of improving signal-to-noise ratio of a portable communication device including a processing unit and an audio engine connected to the processing unit, the method comprising:
acquiring a digital audio signal output from an endec of the processing unit by a processing unit interface;
receiving the digital audio signal transmitted from the processing unit interface by an audio engine interface;
transmitting the digital audio signal from the audio engine interface to an audio engine processor;
reducing noise of the digital audio signal by the audio engine processor and then converting the digital audio signal to an analog audio signal to be played.

2. The method of claim 1, wherein before the step of acquiring the digital audio signal by the processing unit interface further comprising:
encoding/decoding a call data received by the portable communication device by the endec to generate the digital audio signal.

3. The method of claim 1, further comprising:
playing the analog audio signal by an audio player.

4. The method of claim 3, further comprising:
transmitting a music data from the processing unit interface to the audio engine interface;
transmitting the music data from the audio engine interface to the audio engine processor; and
playing the music data processed by the audio player.

5. The method of claim 3, wherein the audio player includes a handsfree device, a telephone receiver, or a headset of the portable communication device.

6. The method of claim 1, wherein the step of reducing the noise of the digital audio signal by the audio engine processor comprises running an audio noise reduction program on the audio engine processor.

7. A signal-to-noise ratio improving system, comprising:
a processing unit including an endec and an processing unit interface, the processing unit interface for receiving a digital audio signal output from the endec;
an audio engine including an audio engine processor and an audio engine interface, the audio engine interface for receiving the digital audio signal transmitted from the processing unit interface;
wherein the audio engine processor is used to receive the digital audio signal transmitted from the audio engine interface, reduce noise of the digital audio signal, and convert the digital audio signal to an analog audio signal to be played.

8. The system of claim 7, wherein the endec is used to encode/decode a call data received by the portable communication device to generate the digital audio signal.

9. The system of claim 7, wherein the processing unit interface is used to transmit a music data to the audio engine interface, and to transmit the music data to the audio engine processor, and the audio engine processor is used to process the music data.

10. The system of claim 7, wherein the system further comprises an audio player used to play the analog audio signal.

11. The system of claim 10, wherein the audio player includes a handsfree device, a telephone receiver, or a headset of the portable communication device.

12. A portable communication device capable of improving signal-to-noise ratio, comprising:
a processing unit including an endec and an processing unit interface, the processing unit interface for receiving a digital audio signal output from the endec;
an audio engine including an audio engine processor and an audio engine interface, the audio engine interface for receiving the digital audio signal transmitted from the processing unit interface;
wherein the audio engine processor is used to receive the digital audio signal transmitted from the audio engine interface, reduce noise of the digital audio signal, and convert the digital audio signal to an analog audio signal to be played.

13. The portable communication device of claim 12 wherein the endec is used to encode/decode a call data received by the portable communication device to generate the digital audio signal.

14. The portable communication device of claim 12, further comprising an audio player to play the analog audio signal.

15. The portable communication device of claim 14, wherein the processing unit interface is used to transmit a music data to the audio engine interface; the audio engine interface is used to transmit the music data to the audio engine processor; and the audio player is used to play the music data.

16. The portable communication device of claim 14, wherein the audio player includes a handsfree device, a telephone receiver, or a headset of the portable communication device.
